(19) United States
(12) Patent Application Publication
(10) Pub. No.: US 2015/0170198 A1
(43) Pub. Date: Jun. 18, 2015

(54) SELF-LEARNING BID OPTIMIZATION METHODS AND SYSTEM BASED ON AUTO-DETECTED CAMPAIGN RULES

(71) Applicant: DSNR Media Group Ltd., RaAnana (IL)

(72) Inventors: Nir Avniel, RaAnana (IL); Boris Levin, Rishon-LeZion (IL)

(21) Appl. No.: 14/487,131

(22) Filed: Sep. 16, 2014

Related U.S. Application Data
(60) Provisional application No. 61/916,359, filed on Dec. 16, 2013.

(51) Int. Cl. G06Q 30/02

(52) U.S. Cl. CPC G06Q 30/0244

(57) ABSTRACT

A bid optimization system optimizes bid amounts in bid records of an information providing or advertising campaigns. The system includes a detection engine for detecting (finding) rules from campaign data, including bid records, from the profit report data of the campaign data. The bid records are organized in a set, which is continuously being updated and revised for profitability, to create a new set of reordered of bid records, based on these detected rules. The detected rules are then applied to the new set of reordered bid records, to optimize the bid amounts of each bid record.

### RELATED APPLICATION

This application claims the benefit of priority under 35 USC 119(e) of U.S. Provisional Patent Application No. 61/916,359 filed Dec. 16, 2013, the contents of which are incorporated herein by reference in their entirety.

### BACKGROUND

The present invention is directed to methods and systems for managing advertising and information providing campaigns, and in particular to bid optimization for information providing, including advertising campaigns.

Mobile and web based advertisers are continuously attempting to optimize the efficiency of their advertising campaigns. For example, these advertisers desire to reach the maximum amount of potentially relevant customers for the strictly limited cost. Contemporary advertising campaigns evaluate various metrics to determine the campaign's efficiency. These metrics include advertising margin, return on investment (ROI), and effective cost per mille (thousand impressions) (eCPM), for example. However, even with these metrics in hand, advertisers continue to lack certainty as to exactly how to increase the efficiency of their campaigns.

### SUMMARY

According to some embodiments of the present invention, there is provided a computer-implemented method performed by a computer system, for optimizing bid amounts in information providing campaigns. The method includes the processes comprising:
a) obtaining data associated with an information providing campaign, the data including profit report data comprised of plural bid records defining a current set of bid records, each one of the plural bid records including a plurality of fields including a field for a bid amount, and the each bid record formed of combinations of one or more conditions, each of the conditions comprising a value for a corresponding field of the bid record;
b) creating a dataset from the combinations of conditions from each one of the plural bid records;
c) categorizing each of the combinations of conditions of the dataset;
d) finding rules from the dataset including at least one rule for creating a new set of bid records from the bid records in the dataset;
e) applying the found rules to the current set of bid records of the data set to create a new set of bid records; and,
f) determining an optimized bid amount for at least one bid record of the plural bid records of the new set of bid records based on the categorizations of the combinations of conditions that form the at least one bid record of the new set of bid records.

Optionally, after the process of paragraph f), the new set of bid records becomes the current set of bid records, and the method additionally includes repeating the processes of paragraphs b) through f).

Optionally, the categories for the combinations of conditions include: 1) a first category corresponding to high profit combinations; 2) a second category corresponding to intermediate profit combinations; and, 3) a third category corresponding to low profit combinations.

Optionally, the profit report data includes data associated with at least one of profit margins or revenues.

Optionally, the creating the new set of bid records comprises at least one of: keeping certain of the current bid records, amending certain of the current bid records, and forming new bid records.

Optionally, the amending certain of the current bid records includes, for each of the certain current bid records, deactivating at least one combination in the certain current bid record.

Optionally, forming the new bid records includes selecting n of the combinations from the dataset to stand alone, wherein n is a positive integer.

Optionally, the finding rules additionally include finding rules for: deactivating bid records, and optimizing bid amounts for bid records.

Optionally, the finding rules for creating a new set of bid records include finding at least one rule for each of: keeping currently existing bid records, creating new bid records, and amending currently existing bid records.

Optionally, the information providing campaign includes an advertising campaign.

Optionally, the data associated with the information providing campaign is associated with at least one of a publisher or an advertiser.

Optionally, the bid records of the new set of bid records are analyzed to determine whether an alert should be issued for the bid records in accordance with an alert criteria.

According to some embodiments of the present invention, there is provided a bid optimization system. The system comprises a rules detection engine in communication with a processor. The rules detection engine performs: a) obtaining data associated with an information providing campaign, the data including profit report data comprised of plural bid records defining a current set of bid records, each one of the plural bid records including a plurality of fields including a field for a bid amount, and the each bid record formed of combinations of one or more conditions, each of the conditions comprising a value for a corresponding field of the bid record; b) creating a dataset from the combinations of conditions from each one of the plural bid records; c) categorizing each of the combinations of conditions of the dataset; and, d) finding rules from the dataset including at least one rule for creating a new set of bid records from the bid records in the dataset. The processor performs: a) applying the found rules to the current set of bid records of the data set to create a new set of bid records; and, b) determining an optimized bid amount for at least one bid record of the plural bid records of the new set of bid records based on the categorizations of the combinations of conditions that form the at least one bid record from the new set of bid records.

Optionally, the rules detection engine additionally performs categorizing the combinations of conditions to include: 1) a first category corresponding to high profit combinations; 2) a second category corresponding to intermediate profit combinations; and, 3) a third category corresponding to low profit combinations.

Optionally, the rules detection engine which performs creating the new set of bid records, additionally performs at least one of: keeping certain of the current bid records, amending certain of the current bid records, and forming new bid records.

Optionally, the rules detection engine which performs the amending certain of the current bid records, additionally performs each of the certain current bid records, deactivating at least one combination in the certain current bid record.

Optionally, the rules detection engine which performs forming the new bid records additionally performs selecting n of the combinations from the dataset to stand alone, wherein n is a positive integer.

Optionally, the rules detection engine for finding rules additionally performs finding rules for: deactivating bid records, and optimizing bid amounts for bid records.

Optionally, the rules detection engine which performs finding rules for creating a new set of bid records, additionally performs finding at least one rule for each of: keeping currently existing bid records, creating new bid records, and amending bid records.

Optionally, the system includes an alert module in communication with the processor, the alert module which performs analyzing the bid records in the new set of bid records to determine whether an alert should be issued for certain of the bid records in accordance with an alert criteria.

According to some embodiments of the present invention, there is provided a computer usable non-transitory storage medium having a computer program embodied thereon for causing a suitable programmed system to optimize bid amounts for bid records, by performing the following steps when such program is executed on the system. The steps comprise:
a) obtaining data associated with an information providing campaign, the data including profit report data comprised of plural bid records defining a current set of bid records, each one of the plural bid records including a plurality of fields, including a field for a bid amount, and the each bid record formed of combinations of one or more conditions, each of the conditions comprising a value for a corresponding field of the bid record;
b) creating a dataset from the combinations of conditions from each one of the plural bid records;
c) categorizing each of the combinations of conditions of the dataset;
d) finding rules from the dataset including at least one rule for creating a new set of bid records from the bid records in the dataset;
e) applying the found rules to the current set of bid records of the data set to create a new set of bid records; and,
f) determining an optimized bid amount for at least one bid record of the plural bid records of the new set of bid records based on the categorizations of the combinations of field values that form the at least one bid record of the new set of bid records.

Optionally, the steps additionally comprise repeating steps b) through h), and prior to the repeating step b), the new set of bid records becomes the current set of bid categories records.

Optionally, the for the combinations of conditions include: 1) a first category corresponding to high profit combinations; 2) a second category corresponding to intermediate profit combinations; and, 3) a third category corresponding to low profit combinations.

Optionally, the profit report data includes data associated with at least one of profit margins or revenues.

Optionally, the creating of the new set of bid records comprises at least one of: keeping certain of the current bid records, amending certain of the current bid records, and forming new bid records.

Optionally, the amending certain of the current bid records includes, for each of the certain current bid records, deactivating at least one combination in the certain current bid record.

Optionally, the forming the new bid records includes selecting n of the combinations from the dataset to stand alone, wherein n is a positive integer.

Optionally, the finding rules additionally include finding rules for: deactivating bid records, and optimizing bid amounts for bid records.

Optionally, the finding rules for creating a new set of bid records include finding at least one rule for each of: keeping currently existing bid records, creating new bid records, and amending bid records.

Optionally, the information providing campaign includes an advertising campaign.

Optionally, the data associated with the information providing campaign is associated with at least one of a publisher or an advertiser.

Optionally, there is an additional step of analyzing the bid records in the new set of bid records to determine whether an alert should be issued for the bid records in accordance with an alert criteria.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the present invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram of an exemplary environment on which embodiments of the present invention are performed;

FIG. 2 is a flow diagram of a process performed in the environment of FIG. 1;

FIG. 3 is a flow diagram for the processes associated with rules for generating alerts, as per the flow diagram of FIG. 2; and

FIG. 4 is a diagram of the data from which optimized bids were obtained.

### DETAILED DESCRIPTION

Some embodiments of the present invention provide systems and methods for optimizing bid amounts for bid records associated with advertising campaigns or information providing campaigns. The system utilizes campaign data, including profit report data and other financial data, to find rules, which are then applied to the bid records. Bid records may be kept intact, reordered, modified or augmented, at various intervals, such that the bid amounts associated with each bid record are optimized.

Some embodiments of the invention disclose a bid optimization process, where bid records are continuously being updated and revised at intervals, in order to maximize their profitability. The process is iterative, and typically performed in real time, as the bid records are continuously being updated by being reordered, along with new bid records being created, so that profit associated with each bid record is maximized.

Some embodiments of the present invention disclose a bid optimization system, which optimizes bid amounts in bid records of advertising or information providing campaigns. The system includes a detection engine for detecting (finding) rules from campaign data, including bid records, from profit report data. The bid records are categorized based on these detected rules, and the detected rules are then applied to the reordered bid records, to optimize the bid amounts of each bid record.

Some embodiments of the present invention disclose methods and systems, provided by apparatus, for advertising campaign management optimization. The disclosed systems are, for example, based on revealing advertising campaign rules that are detected automatically. The found rules are of several types.

There are rules defining the combinations of field values (the field values also known as conditions), which make up the bid records, which include a bid amount. The aforementioned bid records may include Line Items (LIs). The rules define good combinations, bad combinations and intermediate combinations. An additional important application of the found rules, is that they define combinations of field values or conditions, for which new line items should be created in order to ensure, with a high probability, a sufficiently high margin (exceeding the margin goal), and sufficiently high revenue eCPM (not less than revenue eCPM goal).

The rules found should, for example, be those for defining (under different specific conditions) the minimal bid level that ensures (with a high probability and sufficient reliability), a pre-given level of ROI (Facebook®) or a pre-given margin and eCPM (profit report data).

The rules found should also be rules describing regularities in alerts data. These rules when applied to the system, enable users to timely detect bad bid records, e.g., LIs, and to generate alerts immediately. Moreover, these rules are useful in order to understand and document the appearance of such “alert” conditions. Accordingly, the system in accordance with some embodiments of the present invention, creates and stores the alerts data, such that alerts rules are discovered within this data. The found alert regularities (rules) are timely warnings that allow the advertisers or information provided to significantly decrease potential losses from bad line items because they are timely deleted.

Some embodiments of the present invention are such that the system is based on a set of interconnected mathematical models, methods and algorithms. The joint utilization of the auto-detect or rule engine and the online modules enables the advertiser or information provider to raise the total revenue and profit received from their digital advertising or information providing campaigns.

Some embodiments of the present invention are such that all of the rules, which are found and subsequently applied for bid optimization, are continuously recalculated (updated). Some of these rules, for which the confidence has dropped below the minimum rule's probability, are excluded from the set of rules, and the new rules are found. Accordingly, the disclosed methods and systems are dynamic, and a self-learning process.

Some other embodiments of the present invention are directed to selecting a target field and another independent field, and obtaining rules from campaign data for these fields. The parameters from the target field may be advertising margin, return on investment (ROI), and effective cost per mille (thousand impressions) (eCPM). The parameters for the independent fields may include Advertiser Identification (Advertiser_ID), Advertiser Line Item (Advertiser_LI), Publisher Identification (Publisher_ID), Publisher Line Item (Publisher_LI), Banner Size (Banner_Size), Country, Advertiser Pricing Model (Advertiser_pricing_model), Publisher Pricing (Publisher_Pricing), Publisher Pricing Type (Publisher_Pricing_Type), Impressions, Clicks, Conversions, Revenue, Cost, Click Rate (Click_Rate), Conversion Rate (Conversion_Rate), Revenue in effective cost per thousand (Revenue_eCPM), Cost of one thousand impressions (Cost_eCPM), Revenue for effective cost of one thousand impressions (Revenue_eCPA), Profit for the effective cost of one thousand impressions (Profit_eCPM), Advertiser Margin, Day of the week (Day_of_Week). The obtained rules for the fields are used in solving tasks, including defining a set of good line items (LI) for which bids will be increased, and calculating the new values of the bids; defining a set of bad line items, that should be excluded, defining a set of line items for which the corresponding bids are decreased, and calculating the new values of these bids, and, developing recommendations for new line items, and optimizing the values for the bids associated therewith.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored on the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

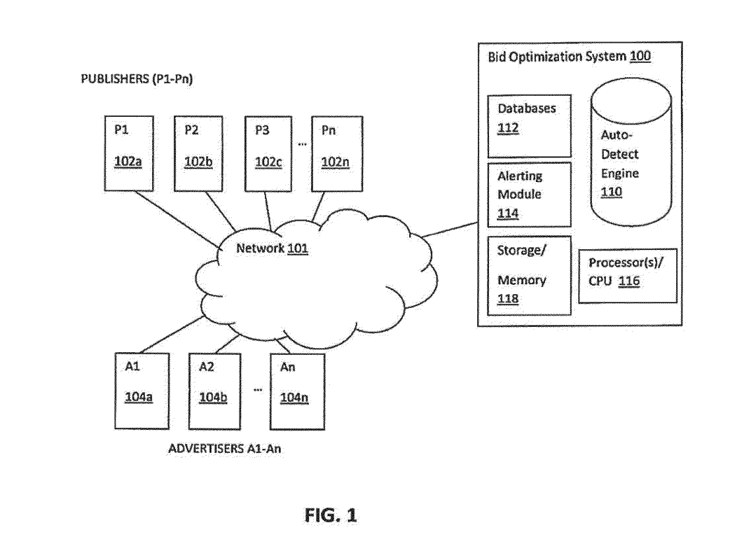

Reference is now made to FIG. 1, which shows an operating environment for a non-limiting exemplary system 100, also known as bid optimization system, in accordance with some embodiments of the present invention. The bid optimization system 100 provides numerous processes, which are used to detect advertising and information providing campaign rules, for mobile and web based advertising and information campaign management optimization.

The bid optimization system 100 is, for example, a computer system, implemented in a user-server configuration according to some embodiments of the present invention, and addressable over a network 101, such as a Local Area Network (LAN), Wide Area Network (WAN), including public networks such as the Internet. Publisher Servers (P1-Pn) 102a-102n, representative of publishers, and Advertiser Servers (A1-An) 104a-104n, representative of advertisers, also link to the network 101, either directly or indirectly.

The bid optimization system 100 includes an auto-detect, or detection, engine 110, databases 112, an alerting module 114, processor(s), including a central processing unit (CPU) 116, and storage/memory 118. The aforementioned components 110, 112, 114, 116, 118, link either directly or indirectly, e.g., through the bid optimization system 100, to the network 101, and also to each other, within the system 100.

The auto-detect engine 110 performs the auto-detection, including the finding of rules from the campaign rules, and then compiles these rules for bid optimization for the requisite advertising or information providing campaign. These processes are detailed below, and performed in both hardware and software, or combinations thereof.

The databases 112 store the components for performing the processes disclosed herein, all rules obtained, parameters, fields and the like. The alerting module 114 issues the various alerts detailed below.

The processors/CPU 116 control the operation of the system 100, and perform applications of the auto-detected or found rules to the bid records to yield optimized bids.

The processors 116 are conventional processors, such as those used in servers, computers, and other computerized devices. The processors 116 may be arranged to have a central processing unit (CPU), for controlling the system 100. For example, the processors may include x86 Processors from AMD and Intel, Xenon® and Pentium® processors from Intel, and other processors Other processors, such as those of the modules, may be any of the aforementioned processors.

The storage/memory 118 is in addition to the databases 112, and includes any conventional storage. This storage/memory 118 stores machine executable instructions, including components, associated with the operation of the system 100. Also, the storage/memory 118, although shown as a single component for representative purposes, may be multiple components, and may be outboard from the system 100, and linked to the network 101.

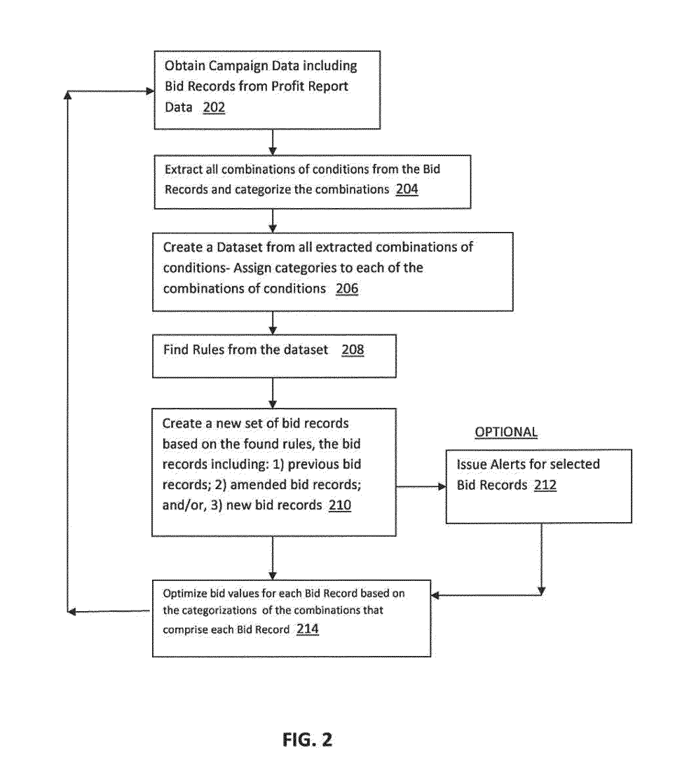

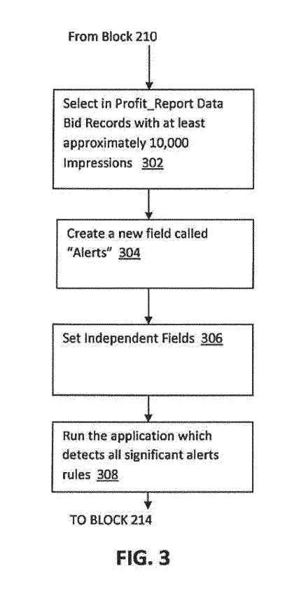

Attention is now directed to FIGS. 2 and 3, which include a main flow diagram (FIG. 2), with a sub flow diagram (FIG. 3) of block 212 of FIG. 2. These flow diagrams detail a computerized process performed by the bid optimization system 100 in accordance with some embodiments of the disclosed subject matter. Reference is also made to elements shown in FIG. 1, as described above. The process is dynamic, in that the process is performed continuously and automatically, as bid records, including LIs, are continuously subjected to being reorganized and recategorized, so that the bid amounts of each bid record can be optimized. The process is, for example, performed in real time, and may be performed at user-desired intervals.

Initially, at block 202, campaign data, including profit report data, for the advertising or information providing campaign for an advertiser or information provider is obtained. The advertiser or information provider may include clearing houses, for example, represented by servers A1-An, 104a-104n, or be a publisher, for example, as represented by publisher servers P1-Pn, 102a-102n. The campaign data is arranged as a compilation of bid records, each including a bid amount, which is typically a monetary amount or monetary value. The bid records include, for example, line items (LIs), advertising units, advertising records, and the like.

Within each bid record, for example, a LI, is profit report data, e.g., financial data associated with the advertisement of the LI, such as, margins, revenues, costs, bids, return on investment. The campaign data may be from one or more advertisers at a single publisher, such as, for example, Facebook®, represented by one or more of the Publisher Servers P1-Pn, or multiple publishers as administered by a clearing house, such as, for example, Rightmedia® and appnexus, who are considered advertisers, represented by one or more of the advertiser servers A1-An.

Since the bid records discussed herein are, for example, line items (LIs), “bid records” and “line items (LIs) are used interchangeably herein. However, LIs are a type of bid records, which like the bid records, include bid amounts.

Initially, from the campaign data, LIs are to be found. These LIs are found by initially considering profit report data containing the following fields:

Advertiser_ID, Advertiser_LI, Publisher_ID, Publisher_LI, Banner_Size, Country, Advertiser_pricing_model, Publisher_Pricing, Publisher_Pricing_Type, Impressions, Clicks, Conversions, Revenue, Cost, Click_Rate, Conversion_Rate, Revenue_eCPM, Cost_eCPM, Revenue_eCPA, Profit_eCPM, Advertiser Margin, Day_of_Week. When these fields, for example, the fields Banner_Size and Country, have values assigned to them, for example, Banner_Size is 234×60, Country is Germany, the fields are referred to as conditions.

A bid record, here, for example, a Line Item, is formed from a plurality of conditions. In each Line Item, the conditions can be split, to create a plurality of combinations of conditions, or simply “combinations”, for that line item. For example, if the Line Item is formed of the combination of conditions, X, Y and Z, condition X can be split into conditions X′ and X″, such that the Line Item has been split into the combinations: X, Y, Z; X′, Y, Z; and X″,Y, Z. Should the field be “Country”, where Condition X is Germany, Condition X′ is Israel, and Condition X″ is France, there are three combinations of conditions for this line item; Combination 1—Germany, Y, Z; Combination 2—Israel, Y, Z; and, Combination 3—France, Y, Z.

The process now moves to block 204, where each of the combinations of conditions, which form each bid record (e.g., LI), are extracted from the respective bid records, e.g., LIs. Each extracted combination is then categorized, based on a selected criteria. This criteria may be, for example, profit data including return on investment (ROI), an industry metric, profit margins, revenues, and the like.

Categorizing Combinations of Conditions from Each of the Bid Records

This process is performed as initially, a single target field is defined. The target field has three possible values: good, intermediate, bad.

An input table is used for defining good and bad combinations of conditions which form each of the bid records. The input table contains, for example, the following fields: Advertiser_ID, Margin_Goal, Margin_Floor.

Here, Margin_Goal, and Margin_Floor are dependent on Advertiser. For example:

for Advertiser 1 (Adv1), Margin_Goal=25% and Margin_Floor=16%;

for Adv2, Margin_Goal=20% and Margin_Floor=14%; and

for Adv3, Margin_Goal=28% and Margin_Floor=15%.

Simultaneously, Revenue_eCPM participates in the definition of a good combination, with fields Revenue_eCPM_Goal and Revenue_eCPM_Floor are given by countries.

There are three values in the Target Field of Table 1, in which Good combinations, Bad combinations and Intermediate combinations, which are defined, as follows:

TABLE 1

| Category | Category | |
|---|---|---|
| Code | Name | Definition |
| 1 | Good | (Margin>= Margin_Goal) & |
| | Combination | (Rev eCPM>= Rev eCPM Goal) |
| 3 | Bad | (Margin< Margin Floor) or |
| | Combination | (Rev eCP M< Rev eCPM Floor) |
| 2 | Intermediate | Not belonging to Category 1 and 3 |
| | Combinations | |

Two types of rules, which are created, are for categorizing the combinations into “good” combinations and “bad” combinations.

Initially, rules for categorizing combinations as “good” combinations are established.

Such a rule has the following structure:
If (condition),
Then there is a great probability of p %
That the combination belongs to Category 1—Good Combinations, i.e., it's margin≧Margin_Goal and simultaneously, it's Revenue_eCPM≧Revenue_eCPM_Goal
The rule's support is n records (Combinations)
The rule's reliability is R

Next, for rules categorizing combinations as “bad” combinations are established.

Such a rule has the following structure:
If (condition),
Then there is a great probability of p %
That combination belongs to Category 3—Bad combinations, i.e., it's margin<Margin_Goal and simultaneously, it's Revenue_eCPM<Revenue_eCPM_Goal
The rule's support is n bid records (LIs)
The rule's reliability is R

The only rules searched for in the advertising or information providing campaign are those where the rule's probability is greater than the given minimum rule's probability, and the rule's support is not less than the given minimum rule's support. The minimum rule's support is a parameter which should be given before running the program. A default value for the minimum rule's support=20.

The minimum rule's probability, for the first type of rules, for Good combinations, and the second type of rules, for Bad combinations is as follows:

### Determining Good Combinations

N is the total number of records in the considered database (rowcount);

M is the number of records where 1) Margin≧Margin_Goal and, 2) Revenue_eCPM≧Revenue_eCPM_Goal. M is the number of good Combinations.

The probability that a Combination belongs to the category GOOD, is expressed as:

av_probability(average probability)=M/N,

with the minimum rule's probability (minimum_probability) defined as:

minimum_probability=av_probability*1.5.

### Determining Bad Combinations

N and M are the same as above for Rules of the First Type.

The minimum rule's probability (minimum_probability) is defined as: minimum_probability=av_probability*1.5, where av_probability=M/N, where, M is the number of BAD Combinations. BAD Combinations are defined as those combinations where,
1) Margin<Margin_Floor and, 2) Revenue_eCPM<Revenue_eCPM_Floor.

The rule's condition is now constructed from the input fields and their values. Examples of rule's conditions (field values) include:

For 1-condition (field value) rules: 1) Country is Israel; 2) Banner_Size is 300×250.

For 2-condition rules: 1) Advertiser is A, and Country is Brazil; 2) Publisher is B, and Banner_Size is 728×90.

For 3-condition rules: Advertiser_LI is BRWN, and Publisher is B, and Banner_Size is pop.

For 4-condition rules: Advertiser is A, and Publisher is B, and Banner_Size is 234×60, and Publisher_Pricing=70%.

The rules containing 5 conditions in their “if” part may be found by applying the pattern above.

The process moves to block 206, where a dataset is created from all of the extracted combinations from all of the bid records for the advertising/information providing campaign. The categories which were created, are then assigned to each combination of the dataset, which was extracted from all of the bid records (e.g., LIs). The rules for categorizing the combinations found above are used in determining which Line Items, based on the combinations that form each line item, are to have their bids optimized. Optimization involves the bid values for the selected bid record either being increased or decreased. These found rules also indicate which combinations are for deactivation, and which combinations are to be deactivated in certain bid records (LIs). These rules also define requirements for creating new LIs from the combinations of the dataset.

From the dataset, rules are now found, at block 208. The rules which are, for example, found automatically by the auto-detect engine 110 (FIG. 1) are for operations including:
1. Creating a New Set of Bid Records
   a. Keeping Currently Existing (Current) Bid Records
   b. Creating New Bid Records
   c. Amending Bid Records by deactivating combinations of conditions in bid records
2. Deactivating bid records
3. Optimizing bids (bid amounts) for bid records

Rule Set 1—Creating a New Set of Bid Records, Rule Set 1a—Keeping Currently Existing (Current) Bid Records, Rule Set 1b—Creating New Bid Records, Rule Set 1c—Amending Bid Records by Deactivating Combinations in Bid Records, and Rule Set 2—Terminating/Deactivating “Bad” Bid Records.

The rules which are found are 1-condition and multi-condition rules, for creating a new set of bid records, deactivating combinations in bid records, and for terminating/deactivating “bad” bid records.

The aforementioned rules for each of the categories are found as the advertising or information provider campaigns are analyzed for regularities in the campaign data. Regularities in profit data reports are searched in accordance with association rules, with a Boolean target field. Initially, there are N records in a database.

The process includes an algorithm, which is initially such that all independent fields are categorical (alphanumeric). The extended algorithm will include fields of a numeric type among input independent fields participating in constructing the rules to be found.

As an example, the data contains k independent categorical fields, X1, X2, . . . , Xk, and a single dependent (or target) field Y. In this example case, when a target field is Boolean, it has only two values, “1” and “0”.

Now, let N be the total number of records in the database, and M be the total number of records with the value of the Target Field is 1.

Pa is the a priori probability that the value of the Target Field is 1, i.e., Pa=P(Y=1), and Pa=M/N.

The algorithm uses two predefined parameters, Nₘᵢₙ, the minimum rule's support, and Pₘᵢₙ, the minimum rule's probability, also known as the minimum rule's confidence.

The minimum support Nmin is the minimum number of records for establishing a rule. Nmin is parameter that is defined before running the algorithm. Nmin can be defined as a certain percentage of N (for example, 0.5% of N, that is, Nmin=0.005*N), or as a pre-given minimum number of records (e.g. N=100).

The minimum rule's probability (in data mining terms, it is referred to as the rule's confidence) Pmin is specified beforehand as well. Pmin can be given as follows:

Pmin=(Pa+1)/2

For example, if Pa=0.01 (1%), then Pmin=0.505 (50.5%). If Pa=0.1 (10%), then Pmin=0.505 (55%).

Consider a fixed potential rule's condition. For this purpose, Groups are created for each independent field separately, with sorting by corresponding number of records for values of the considered field.

For example, in Grouping by Advertiser with sorting in decreasing order of record count, only Advertisers whose count is not less than Nmin are considered. For each advertiser, in addition to total record count, the number of records for which the target field possesses the value of 1 is computed. The number of records belonging to the considered advertiser is denoted by n, and among them, the number of records where the target field=1, denoted by m. The probability p is now calculated, for an arbitrary LI belonging to this advertiser, and the target field possesses a value of 1 and, p=m/n.

If m/n≧Pmin, the rule has been detected as follows: If Advertiser is AAA, the, there is a probability of p, whereby the target field's value is 1. The rule exists in records and the rule has a reliability of R.

Note that the inequality n≧Nmin is fulfilled automatically because as mentioned above, the set of advertisers is defined.

The 1-condition rules for other independent input fields, such as, for example, Publisher_ID, Banner_Size, Country, Advertiser_LI, Publisher_LI, Advertiser_Pricing_Model, Publisher_Pricing_Type, are detected analogously.

As a result, all 1-condition rules are found. Simultaneously, a list of all representative 1-conditions is created. A representative 1-condition is a condition such that that the number of records satisfying this condition is greater than or equal to Nmin.

2-condition rules, i.e., conditions containing two fields, are now searched for. It is important to note that when constructing the representative 2-conditions, only representative 1-conditions are used (for this purpose, as mentioned above, a list of all representative 1-conditions are previously created). For each representative 2-condition, the number n of records satisfying this condition is known, and moreover, among them, the number m of records having a value of 1 in the target field is determined.

The probability p=m/n is calculated.

If p≧Pmin (and simultaneously, by the construction, n≧Nmin), then the 2-condition rule has been detected. A 2-condition rule is formulated as 1-condition rule presented above, but in the “if” part of the rule, two 1-conditions are contained. An example of a two-condition rule is the following:

(Advertiser is AAA) & (Publisher is BBB).

Accordingly, all 2-condition rules are found. Simultaneously, a list of all representative 2-conditions is created.

3-condition rules are now searched for. These 3-condition rules are based on representative 2-conditions and representative 1-conditions. An example of 3-condition rule is the following:

(Advertiser is AAA) & (Publisher is BBB) & (Banner_Size is 728×90).

In the general case, k-condition rules are found based on representative (k−1)-conditions and representative 1-conditions.

In particular, the following association rule can be found:

If (Advertiser is AAA) & (Publisher is BBB) & (Country is France) & (Banner_Size is 300×250), then, there is a probability of 80%.

The Target Field value is 1 (specifically, the “Margin is more than 30%”). The rule exists in 250 records and the reliability of the rule is 75%.

### Rule Set 3—Bid Optimization

The rules for bid optimization are now found. In this process, the advertising or information providing campaign rules are detected which contain numeric independent values. This is done by expanding the algorithm for the alphanumeric fields created above.

In this case, association rules are found when there are input fields (independent) fields of the numeric type.

As previously, Nmin will denote the pre-given minimum support, that is, the minimum number of records necessary for establishing a rule.

The minimum rule's probability (generally referred to as “the rule's confidence”) Pmin is pre-given as well. At first an initial discretization algorithm for each numeric field is applied.

a. Initial Discretization Algorithm

This initial discretization algorithm results in obtaining boundary points for optimal intervals, which will be constructed.

Using a fixed numeric field, the field is sorted in descending order of its values.

Let X[i], i=0, . . . , N−1 represent this field's values in the sorted field. Here N is the total number of records in the considered database (rowcount).

Consider X[Nmin]. Additionally, the number of records satisfying the condition x≧X[Nmin] is greater than Nmin (here, x is the value of this field).

Consider X[N−Nmin−1]. The number of records satisfying the condition x≦X[N−Nmin−1] is greater than Nmin.

The result of the considered discretization algorithm is the array Y[j], j=0, . . . , K−1. The array Y[j] is the array of boundary values, and K is the number of boundary values.

K is a parameter. By default, K=30.

The algorithm operates as follows:

Y[O] = X[Nmin];
Y[K−1] = X[N − Nmin − 1];
z = (Y[O] − Y[K − 1])/(K − 1);
for (j = 1; j < K − 1; j ++)
Y[j] = Y[j − 1] − z;

An optimization criterion of maximum reliability R[j] is applied. For the relation x≧Y[j], the optimal value for j, the boundary values, represented as jₒₚₜ is expressed as:

jₒₚₜ₌arg max_{j=0, . . . , K-1} R[j]

Accordingly, when association rules are searched for, the array Y[j], j=0, . . . , K−1, is considered, instead of the numeric field itself.

It is optional, that when the array Y[j], j=0, . . . , K−1, is exactly identical to the initial values of the numeric field in the case when total number of this field's values is relatively small (e.g., not greater than 70). For example, the field “Start Bid” has 40 different values in the interval from 0.08 to 0.61, and also the values: 0.7, 1.1, 1.21. This field can be considered as orderable with fixed numeric values.

Association rules (Rule i) are now determined, for both 1-condition and multi-condition rules. The analysis below is used in the determination if a rule is to be accepted.

b. One-Condition Rules

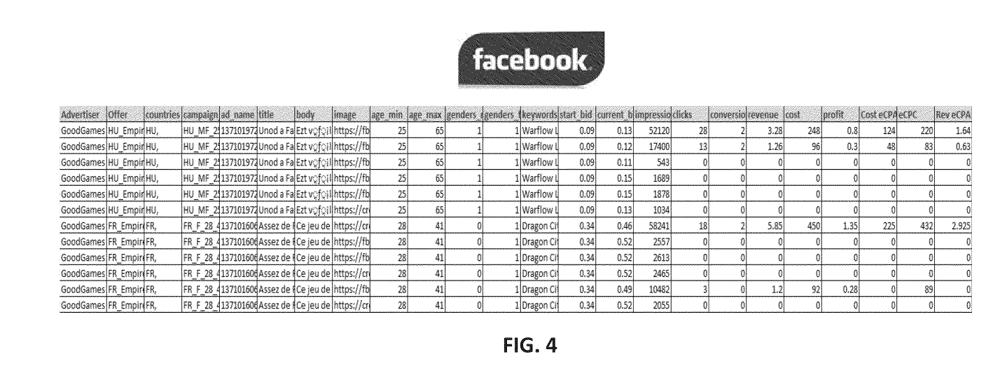

For each numeric field (for example, the numeric fields shown in FIG. 4), the following array of Table 2 is created:

TABLE 2

| | | Number | Among them, | | Reliability | Reliability |
|---|---|---|---|---|---|---|
| | Boundary | of records where | having the | Probability | for relation | for relation |
| j | value Y[j] | x ≧ Y[j] | target field = 1 | p[j] | x ≧ Y[j] | x < Y[j] |
| 0 | Y[0] | n[0] | m[0] | p[0] | R[0] | RL[0] |
| 1 | Y[1] | n[1] | m[1] | p[1] | R[1] | RL[1] |
| . . . | . . . | . . . | . . . | | . . . | . . . |
| j | Y[j] | n[j] | m[j] | p[j] | R[j] | RL[j] |
| . . . | . . . | . . . | . . . | | . . . | . . . |
| K − 1 | Y[K − 1] | n[K − 1] | m[K − 1] | p[K − 1] | R[K − 1] | RL[K − 1] |

The probability p[j] that the target field has a value of 1 is calculated by the formula:

P[j]=m[j]/n[j].

Reliability R[j] is calculated only for those values of j for which the probability p[j] is greater than the minimum rule's probability Pmin, i.e., for values of j such that P[j]>Pₘᵢₙn.

Reliability RL[j] is calculated only for those j for which the following inequality is fulfilled:

$$\frac{M - m [ j ]}{N - n [ j ]} > {P}_{m i n}$$

Given n[j],m[j], the total number of records N, the total number M of records where the target field=1, the reliability R[j] is calculated as follows:

$$R [ j ] = \frac{m [ j ] * N - n [ j ] * M}{\sqrt{n [ j ] * ( N - n [ j ] ) * M * ( N - m )}}$$

Reliability RL[j] for the relation x<Y[j] is calculated by the same formula where:

N[j]=N−n[j]; and M[j]=M−m[j].

Accordingly, all values R[j], RL[j], for j=O, . . . , K−1, are calculated. It can be proved that

−1≦R[j]≦1; and −1≦RL[j]≦1.

Note that R[j] as well as RL[j] is negative when there is a negative correlation.

Among all calculated R[j], RL[j], the maximum value is selected, and for this j the corresponding rule is formulated. Mathematically, the j1 for which the rule is created is chosen as follows:

j1=arg maxj=o . . . , K−1 max (R[j], RL[j])

If the above-mentioned maximum is achieved for reliability R[j], then the following rule is discovered (found):

If the value of the numeric field is greater than or equal to Y[j1], then there is a probability of p[j], and that the value of the target field is 1. (That is, if the target field defines good LIs, then the rule's conclusion is formulated as follows: “That LI is GOOD”).

If the above-mentioned maximum is achieved for reliability RL[j], then the following rule is discovered:

If the value of the numeric field is less than Y[j1],

Then there is a probability of p[j], and that the value of the target field is 1. Moreover, based on the described method, the following rules can be found:

If the value of the numeric field is between Y[j1] and Y[j2], then there is a probability of p (p>Pmin), and the value of the target field is 1.

There are two necessary conditions for such rule's existence: 1) the number of records having the considered numeric field's value belonging to the interval (Y[j1], Y[j2]) is not less than Nmin; and, 2) the rule's probability p is greater than both the rule's probability p[j1] for Y[j1] and the rule's probability p[j2] for Y[j2].

c. Multi-Condition Rules

As mentioned in the main algorithm for detecting association rules, simultaneously with finding all k-condition rules, a list of all representative k-conditions is created as well. A representative k-condition is a condition where the number of records satisfying this condition is greater than or equal to Nmin.

In order to detect (k+1) condition rules by adding the numeric field X[i] (for which the array Y[j], j=0, . . . , K−1 of boundary values was previously created), the above-described algorithm is applied to the set of records satisfying a fixed representative k-condition. This means that N in the above algorithm means the number of records satisfying the considered representative k-condition, and M, means the number of records (among these N records) where the value of the target field is equal to 1.

Accordingly, if the above-mentioned two necessary conditions for accepting a rule are fulfilled, the (k+1)-condition rule contains the numeric field X[i].

The process now moves to block 210, where the rules found from the dataset (at block 208) are applied to the bid records of advertiser's or information provider's campaign, for example, the bid records of the data set (created at block 206 and detailed above) to create a new set of bid records (e.g., Line Items). The new set of bid records may include, one or more of the following bid record (e.g., Line Item) types: 1) previous bid records (e.g., previous line items); 2) amended bid records (e.g., amended line items); and, 3) new bid records (e.g., new line items).

Previous bid records include those bid records which remain completely intact, with all of their combinations the same in the new set as they existed in the previous set of bid records (LIs) (before this new set of bid records (LIs) was created).

Amended bid records include bid records, with some of the combinations of which were active for that bid record in the previous set of bid records now deactivated, or newly added, or combinations thereof.

New bid records include bid records created from one or more combinations, which did not appear as bid records n the previous set of bid records.

The process now moves to block 214, where bid values are optimized for each bid record (e.g., line item) based on the categorizations of each of the combinations of conditions that comprise each line item.

For example, the Facebook® Data of FIG. 4, to which attention is also directed, is used, and the Return on Investment (ROI) is considered as the dependent variable and the target field.

The rules may be applied as follows:

1. If (Advertiser is GoodGames Studio) & (Country is AE) & (Current_Bid≦$0.28), then, there is a probability of 95%, that ROI<70%. The rule's support is 20 records.

2. If (Advertiser is GoodGames Studio) & (Country is AE) & (Current_Bid≧$0.46), then, there is a probability of 92%, that ROI>100%. The rule's support is 27 records.

3. If (Advertiser is GoodGames Studio) & (Offer is BR_BigFarm) & (Country is BR) & (Age is between 18 and 20) & (Gender is Female) & (Current_Bid≦$0.41), then, there is a probability of 97%, that ROI<70%. The rule's support is 31 records.

Generally, the bid is increased until ROI exceeds at least 100%.

Rules 1 and 3 above state that under the relevant rule's condition, the start value of bid should be given at least greater than $0.28 and $0.41, respectively.

Additionally, Rule 2 states that if Advertiser is GoodGames Studio, and Country is AE, then the start value of bid should be specified as $0.46. This bid value was found as a result of solving the optimization problem where the optimization criterion is to maximize the reliability R[j] calculated by the formula for multi-condition rules, detailed above. The reliability R[j] takes into account the rule's probability (the rule's confidence) and the rule's representativeness as well.

Thus, the mathematical formulation of bid optimization task is as follows:

For each line item (LI), find the minimal bid level ensuring (with a high probability “p[j]” and sufficient reliability “R[j]), a pre-given level of ROI (e.g., for ®), or a pre-given margin and eCPM (profit report data).

Assume that a new LI is created, where the Advertiser is GoodGames Studio and Country is AE, and as mentioned above, the start bid range is given equal to $0.46. The reason for this bid value is the above Rule 2, which was found. Since this bid level was sufficient to achieve the required ROI level from the same audience previously, this bid range, at present, is sufficient.

If nevertheless the required traffic, and consequently, the required ROI level is not received, the current bid value is increased periodically (e.g. for ®, every half an hour the system can increase the bid in 10% from the starting bid). If after k rounds there is no required improvement (k is a parameter; by default, for example, k=12), then the corresponding LI is excluded.

From block 214, the process returns to block 202, where the process executes again. As the process is iterative, the process is typically executed at regular intervals, in order to account for changing patterns in the advertising or information providing campaigns. Such intervals are hourly, daily and in some cases weekly. However the process repeating itself need not be at regular intervals, and can be repeated when desired by a system administrator or the like.

Turning back to block 210, the process optionally moves to block 212, where in an optional process, alerts may be issued for certain bid records, for example, certain LIs.

Attention is also directed to FIG. 3, which is a detailed diagram of block 212, where bid records are analyzed in accordance with rules determining if an alert should be generated for these bid records. These alert issuing rules are also found rules from the data set.

Alerts are generated under the following three conditions, with each condition also representing a level for the alert, of a different severity. The alerts and levels of severity are as follows.

An “alert” is at the lowest level. This “alert” is a warning on bad current results for a certain Advertiser_LI related to a fixed Publisher, Publisher_LI, Country. It is color coded green.

An “alarm” is a mid-level serious warning that requires immediate action to correct a bad situation for this bad combination of Advertiser_LI, Publisher, Publisher_LI, Country. It is color coded in red.

An “automatic exclusion, is the highest level and most severe. It results from a bad combination with a certain Advertiser_LI, and should be terminated. As a rule, this is a case when a certain Advertiser_LI, is related to a fixed Publisher, Publisher_LI, Country. Both an “alert” and “alarm” were received previously, and revenues continue to be 0, or almost zero.

The formal conditions, also known as formal combinations of field values, for the above-mentioned alerts are illustrated in the following Table 3:

TABLE 3

| Alert Type | Formal Condition |
|---|---|
| Alert-in green | ((Impressions >=10,000) & (Revenue=O) |
| | & (Clicks< 10)) or |
| | ((Impressions >=20,000) & (Revenue=O)) |
| Alarm-in red | (Impressions >=50,000) & (Revenue=O) |
| Automatic | (Impressions >=100,000) & (Revenue=O) |
| Exclusion | |

Table 3 also defines a process in an algorithm for determining alerts. In determining the types of alerts, as above, the numbers in the alert types' definitions should be considered as parameters. Moreover, the above alert definitions can be extended whereby introducing some additional parameters such as conversion rate (CR), click rate (CTR), conversions per impression.

At block 302, to which the process moves from block 202, in the Profit_Report data, only bid records (e.g., Line Items) having not less than approximately 10,000 impressions are selected. These selected line items are those which could theoretically receive an alert. The mentioned number of impressions, e.g., 10,000, should be considered as parameter.

At block 304, a new field called “Alerts” is created. This “Alerts” field is considered as target field. This “Alerts” field has the following values: 0 (zero), where the LI does not have an alert; 1 (one), where the above-formulated conditions for an “alert” (in green), are fulfilled; 2 (two), where the above-formulated conditions for an “alarm” (in red) are fulfilled; 3 (three), where the above-formulated conditions for Automatic Exclusion are fulfilled.

At block 306, independent input fields are established or set. These independent input fields are considered to be the following: Advertiser_ID, Advertiser_LI, Publisher_ID, Publisher_LI, Size (Banner), Country, Adv_Pricing_Model, Publisher_Pricing_Type. All these fields are of categorical type. Additionally, some numeric variables such as Click Rate (CR), Click Through Rate (CTR) can be considered as independent variables when searching for the alerts association rules.

At block 308, the application that detects all significant alerts rules, in accordance Table 3, as defined above, is run.

Regardless of whether or not an alert was generated, the process moves to block 214. Block 214 has been discussed above.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, including correlation modules, management modules, and optional alerting modules, with associated processors and storage/memory, will be developed and the scope of the term module, processors and storage/memory is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for optimizing bid amounts in information providing campaigns, comprising:
a) obtaining data associated with an information providing campaign, said data including profit report data comprised of plural bid records defining a current set of bid records, each one of said plural bid records including a plurality of fields including a field for a bid amount, and said each bid record formed of combinations of one or more conditions, each of said conditions comprising a value for a corresponding field of said bid record;
b) creating a dataset from said combinations of conditions from each one of said plural bid records;
c) categorizing each of said combinations of conditions of said dataset;
d) finding rules from said dataset including at least one rule for creating a new set of bid records from said bid records in the dataset;
e) applying said found rules to said current set of bid records of said data set to create a new set of bid records; and,
f) determining an optimized bid amount for at least one bid record of said plural bid records of said new set of bid records based on the categorizations of the combinations of conditions that form said at least one bid record of said new set of bid records.

2. The computer-implemented method of claim 1, wherein after paragraph f), said new set of bid records becomes said current set of bid records, and the method additionally comprises:
g) repeating paragraphs b) through f).

3. The computer-implemented method of claim 1, wherein said categories for said combinations of conditions include: 1) a first category corresponding to high profit combinations; 2) a second category corresponding to intermediate profit combinations; and, 3) a third category corresponding to low profit combinations.

4. The computer-implemented method of claim 3, wherein said profit report data includes data associated with at least one of profit margins or revenues.

5. The computer-implemented method of claim 3, wherein said creating said new set of bid records comprises at least one of: keeping certain of said current bid records, amending certain of said current bid records, and forming new bid records.

6. The computer-implemented method of claim 5, wherein said amending certain of said current bid records includes, for each of said certain current bid records, deactivating at least one combination in said certain current bid record.

7. The computer-implemented method of claim 5, wherein said forming said new bid records includes selecting n of said combinations from said dataset to stand alone, wherein n is a positive integer.

8. The computer-implemented method of claim 1, wherein said finding rules additionally includes finding rules for: deactivating bid records, and optimizing bid amounts for bid records.

9. The computer-implemented method of claim 1, wherein said finding rules for creating a new set of bid records includes at finding at least one rule for each of: keeping currently existing bid records, creating new bid records, and amending currently existing bid records.

10. The computer-implemented method of claim 1, wherein said information providing campaign includes an advertising campaign.

11. The computer-implemented method of claim 10, wherein said data associated with said information providing campaign is associated with at least one of a publisher or an advertiser.

12. The computer-implemented method of claim 1, wherein said bid records of said new set of bid records are analyzed to determine whether an alert should be issued for said bid records in accordance with an alert criteria.

13. A bid optimization system comprising:
a detection engine which performs:
a) obtaining data associated with an information providing campaign, said data including profit report data comprised of plural bid records defining a current set of bid records, each one of said plural bid records including a plurality of fields including a field for a bid amount, and said each bid record formed of combinations of one or more conditions, each of said conditions comprising a value for a corresponding field of said bid record;
b) creating a dataset from said combinations of conditions from each one of said plural bid records;
c) categorizing each of said combinations of conditions of said dataset; and,
d) finding rules from said dataset including at least one rule for creating a new set of bid records from said bid records in the dataset; and,
a processor in communication with the detection engine, said processor which performs:
a) applying said found rules to said current set of bid records of said data set to create a new set of bid records; and,
b) determining an optimized bid amount for at least one bid record of said plural bid records of said new set of bid records based on the categorizations of the combinations of conditions that form said at least one bid record from said new set of bid records.

14. The bid-optimization system of claim 13, wherein said detection engine additionally performs categorizing said combinations of conditions to include: 1) a first category corresponding to high profit combinations; 2) a second category corresponding to intermediate profit combinations; and, 3) a third category corresponding to low profit combinations.

15. The bid-optimization system of claim 13, wherein said detection engine which performs creating said new set of bid records, additionally performs at least one of: keeping certain of said current bid records, amending certain of said current bid records, and forming new bid records.

16. The bid-optimization system of claim 15, wherein said detection engine which performs said amending certain of said current bid records, additionally performs each of said certain current bid records, deactivating at least one combination in said certain current bid record.

17. The bid-optimization system of claim 15, wherein said detection engine which performs forming said new bid records additionally performs selecting n of said combinations from said dataset to stand alone, wherein n is a positive integer.

18. The bid-optimization system of claim 13, wherein said detection engine for finding rules additionally performs finding rules for: deactivating bid records, and optimizing bid amounts for bid records.

19. The bid-optimization system of claim 13, wherein said detection engine which performs finding rules for creating a new set of bid records, additionally performs finding at least one rule for each of: keeping currently existing bid records, creating new bid records, and amending bid records.

20. The bid-optimization system of claim 13, additionally comprising an alert module in communication with said processor, said alert module which performs analyzing said bid records in said new set of bid records to determine whether an alert should be issued for certain of said bid records in accordance with an alert criteria.

21. A computer usable non-transitory storage medium having a computer program embodied thereon for causing a suitable programmed system to optimize bid amounts for bid records, by performing the following steps when such program is executed on the system, the steps comprising:
a) obtaining data associated with an information providing campaign, said data including profit report data comprised of plural bid records defining a current set of bid records, each one of said plural bid records including a plurality of fields, including a field for a bid amount, and said each bid record formed of combinations of one or more conditions, each of said conditions comprising a value for a corresponding field of said bid record;
b) creating a dataset from said combinations of conditions from each one of said plural bid records;
c) categorizing each of said combinations of conditions of said dataset;
d) finding rules from said dataset including at least one rule for creating a new set of bid records from said bid records in the dataset;
e) applying said found rules to said current set of bid records of said data set to create a new set of bid records; and,
f) determining an optimized bid amount for at least one bid record of said plural bid records of said new set of bid records based on the categorizations of the combinations of field values that form said at least one bid record of said new set of bid records.

22. The computer usable non-transitory storage medium of claim 21, wherein the steps additionally comprise:
g) repeating said steps b) through h), and prior to said repeating step b) said new set of bid records becomes said current set of bid records.

23. The computer usable non-transitory storage medium of claim 21, wherein said categories for said combinations of conditions include: 1) a first category corresponding to high profit combinations; 2) a second category corresponding to intermediate profit combinations; and, 3) a third category corresponding to low profit combinations.

24. The computer usable non-transitory storage medium of claim 23, wherein said profit report data includes data associated with at least one of profit margins or revenues.

25. The computer usable non-transitory storage medium of claim 23, wherein said creating said new set of bid records comprises at least one of: keeping certain of said current bid records, amending certain of said current bid records, and forming new bid records.

26. The computer usable non-transitory storage medium of claim 25, wherein said amending certain of said current bid records includes, for each of said certain current bid records, deactivating at least one combination in said certain current bid record.

27. The computer usable non-transitory storage medium of claim 25, wherein said forming said new bid records includes selecting n of said combinations from said dataset to stand alone, wherein n is a positive integer.

28. The computer usable non-transitory storage medium of claim 21, wherein said finding rules additionally includes finding rules for: deactivating bid records, and optimizing bid amounts for bid records.

29. The computer usable non-transitory storage medium computer-implemented method of claim 21, wherein said finding rules for creating a new set of bid records includes at finding at least one rule for each of: keeping currently existing bid records, creating new bid records, and amending bid records.

30. The computer usable non-transitory storage medium of claim 21, wherein said information providing campaign includes an advertising campaign.

31. The computer usable non-transitory storage medium of claim 30, wherein said data associated with said information providing campaign is associated with at least one of a publisher or an advertiser.

32. The computer usable non-transitory storage medium of claim 21, additionally comprising the step of:
g) analyzing said bid records in said new set of bid records to determine whether an alert should be issued for said bid records in accordance with an alert criteria.
